(19) United States
(12) Patent Application Publication
(10) Pub. No.: US 2026/0195444 A1
(43) Pub. Date: Jul. 9, 2026

(54) A Method of Assessing Inputs Fed to an AI Model and a Framework Thereof

(71) Applicants: Robert Bosch GmbH, Stuttgart (DE); Bosch Global Software Technologies Private Limited, Bangalore (IN)

(72) Inventors: Sarthak Gupta, Indore (IN); Manojkumar Somabhai Parmar, Ahmedabad, Gujarat (IN); Pavan Kulkarni, Karnataka (IN); Govindarajulu Yuvaraj, Bengaluru, Karnataka (IN)

(21) Appl. No.: 19/132,504

(22) PCT Filed: Nov. 29, 2022
(86) PCT No.: PCT/EP2023/083571

§ 371 Date: May 23, 2025

(30) Foreign Application Priority Data
Nov. 29, 2022 (IN) 2022 4106 8480

(51) Int. Cl. G06F 21/55

(52) U.S. Cl. CPC G06F 21/55

(57) ABSTRACT

A method of assessing inputs fed to an AI Model in an AI system is disclosed. The AI system includes the AI Model, a processing unit and at least a blocker module. The AI Model is configured to classify an input into at least two classes which includes a first class and a second class. The at least two classes are segregated by a classification boundary. The processing unit is configured to calculate a distance between an input lying in the first class from the classification boundary. The processing unit assesses the input based on the calculated distance. The blocker module blocks or restricts at least one user based on the assessment received.

### COMPLETE SPECIFICATION

The following specification describes and ascertains the nature of this invention and the manner in which it is to be performed.

### FIELD OF THE INVENTION

The present disclosure relates to the field of Artificial Intelligence security. In particular, it proposes a method of assessing input fed to an AI model of an AI system.

### BACKGROUND OF THE INVENTION

With the advent of data science, data processing and decision making systems are implemented using artificial intelligence modules. The artificial intelligence modules use different techniques like machine learning, neural networks, deep learning etc. Most of the AI based systems, receive large amounts of data and process the data to train AI models. Trained AI models generate output based on the use cases requested by the user. Typically the AI systems are used in the fields of computer vision, speech recognition, natural language processing, audio recognition, healthcare, autonomous driving, manufacturing, robotics etc. where they process data to generate required output based on certain rules/intelligence acquired through training.

To process the inputs and give a desired output, the AI systems use various models/algorithms which are trained using the training data. Once the AI system is trained using the training data, the AI systems use the models to analyze the real time data and generate appropriate result. The models may be fine-tuned in real-time based on the results. The models in the AI systems form the core of the system. Lots of effort, resources (tangible and intangible), and knowledge goes into developing these models.

It is possible that some adversary may try to tamper/manipulate/evade the model in AI Systems to create incorrect outputs. The adversary may use different techniques to manipulate the output of the model. One of the simplest techniques used by the adversary is where the adversary sends queries to the AI system using his own test data to compute or approximate the gradients through the model. Based on these gradients, the adversary can then manipulate the input in order to manipulate the output of the Model. Another technique is wherein the adversary may manipulate the input data to bring an artificial output. This will cause hardships to the original developer of the AI in the form of business disadvantages, loss of confidential information, loss of lead time spent in development, loss of intellectual properties, loss of future revenues etc. Hence there is a need to assess the input that is fed to the AI Model.

There are methods known in the prior arts on the method of attacking an AI System. The prior art WO2021/095984 A1-Apparatus and Method for Retraining Substitute Model for Evasion Attack and Evasion attack Apparatus discloses one such method. The method talks about retraining a substitute model that partially imitates the target model by allowing the target model to misclassify for specific attack data.

### BRIEF DESCRIPTION OF THE ACCOMPANYING DRAWINGS

An embodiment of the invention is described with reference to the following accompanying drawings:

FIG. 1 depicts an AI system adapted to assess an input fed to an AI Model;

FIG. 2 illustrates method steps of assessing an input fed to an AI model.

### DETAILED DESCRIPTION OF THE DRAWINGS

It is important to understand some aspects of artificial intelligence (AI) technology and artificial intelligence (AI) based systems or artificial intelligence (AI) system. Some important aspects of the AI technology and AI systems can be explained as follows. Depending on the architecture of the implements AI systems may include many components. One such component is an AI module. An AI module with reference to this disclosure can be explained as a component which runs a model. A model can be defined as reference or an inference set of data, which is use different forms of correlation matrices. Using these models and the data from these models, correlations can be established between different types of data to arrive at some logical understanding of the data. A person skilled in the art would be aware of the different types of AI models such as linear regression, naïve bayes classifier, support vector machine, neural networks and the like. It must be understood that this disclosure is not specific to the type of model being executed in the AI module and can be applied to any AI module irrespective of the AI model being executed. A person skilled in the art will also appreciate that the AI module may be implemented as a set of software instructions, combination of software and hardware or any combination of the same.

Some of the typical tasks performed by AI systems are classification, clustering, regression etc. Majority of classification tasks depend upon labeled datasets; that is, the data sets are labelled manually in order for a neural network to learn the correlation between labels and data. This is known as supervised learning. Some of the typical applications of classifications are: face recognition, object identification, gesture recognition, voice recognition etc. In a regression task, the model is trained based on labeled datasets, where the target labels are numeric values. Clustering or grouping is the detection of similarities in the inputs. The cluster learning techniques do not require labels to detect similarities. Learning without labels is called unsupervised learning. Unlabeled data is the majority of data in the world.

As the AI module forms the core of the AI system, the module needs to be protected against attacks. AI adversarial threats can be largely categorized into-model extraction attacks, inference attacks, evasion attacks, and data poisoning attacks. In poisoning attacks, the adversarial carefully inject crafted data to contaminate the training data which eventually affects the functionality of the AI system. Inference attacks attempt to infer the training data from the corresponding output or other information leaked by the target model. Studies have shown that it is possible to recover training data associated with arbitrary model output. Ability to extract this data further possess data privacy issues. Evasion attacks are the most prevalent kind of attack that may occur during AI system operations. In this method, the attacker works on the AI algorithm's inputs to find small perturbations leading to large modifications of its outputs (e.g., decision errors) which leads to evasion of the AI model.

In Model Extraction Attacks (MEA), the attacker gains information about the model internals through analysis of input, output, and other external information. Stealing such a model reveals the important intellectual properties of the organization and enables the attacker to craft other adversarial attacks such as evasion attacks. This attack is initiated through an attack vector. In the computing technology a vector may be defined as a method in which a malicious code/virus data uses to propagate itself such as to infect a computer, a computer system or a computer network. Similarly, an attack vector is defined a path or means by which a hacker can gain access to a computer or a network in order to deliver a payload or a malicious outcome. A model stealing attack uses a kind of attack vector that can make a digital twin/replica/copy of an AI module.

The attacker typically generates random queries of the size and shape of the input specifications and starts querying the model with these arbitrary queries. This querying produces input-output pairs for random queries and generates a secondary dataset that is inferred from the pre-trained model. The attacker then take this I/O pairs and trains the new model from scratch using this secondary dataset. This is a black box model attack vector where no prior knowledge of original model is required. As the prior information regarding model is available and increasing, attacker moves towards more intelligent attacks.

An AI Model trained for classification tasks is trained to learn classification boundary between various classes. Hence important metric to analyze the inputs, is their position with respect to the classification boundary. However, obtaining these positions is difficult as the input spaces are often high dimensional, and the model classification boundaries can be hard to locate. In this invention, we propose to assess each input fed to such AI model in terms of its distance from the classification boundary.

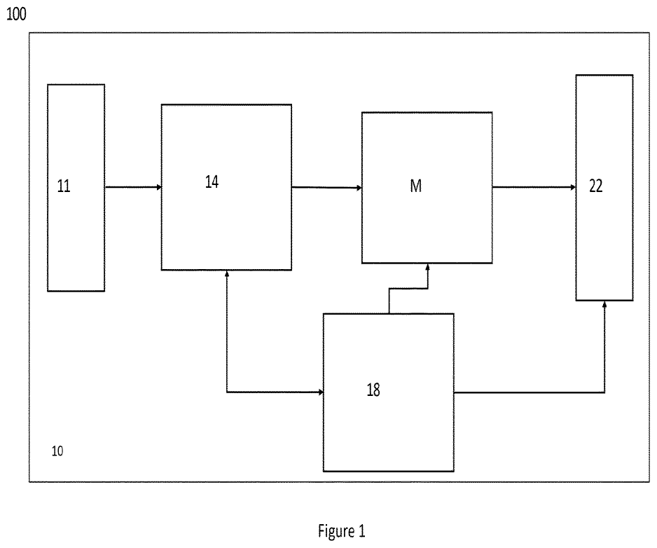

FIG. 1 depicts an AI system (10) adapted to assess an input fed to an AI Model (M). The AI system (10) comprises the AI Model (M), processing unit (14) and at least a blocker module (18) amongst other components known to a person skilled in the art such as the input interface (11), output interface (22) and the like. For simplicity only components having a bearing on the methodology disclosed in the present invention have been elucidated.

As used in this application, the terms “component,” “system,” “module,” “interface,” are intended to refer to a computer-related entity or an entity related to, or that is part of, an operational apparatus with one or more specific functionalities, wherein such entities can be either hardware, a combination of hardware and software, software, or software in execution. As further yet another example, interface(s) can include input/output (I/O) components as well as associated processor, application, or Application Programming Interface (API) components. A module with reference to this disclosure refers to a logic circuitry or a set of software programs that respond to and processes logical instructions to get a meaningful result. The AI system (10) could be a hardware combination of these modules or could be deployed remotely on a cloud or server.

The AI Model (M) is configured to classify an input into at least two classes-a first class and a second class, said at least two classes segregated by a classification boundary. The classification boundaries of a classifier is a set of hyper-surfaces in the input space, which divide the input spaces into several regions such that each contains datapoints with a single class. The classification boundary in simpler term can be defined as a mathematical separation between the various classes that the AI Model (M) is trained to classify an input into.

The most important non-limiting feature of the AI system (10) is the processing unit. The processing unit (14) may be implemented as any or a combination of: one or more microchips or integrated circuits interconnected using a parent board, hardwired logic, software stored by a memory device and executed by a microprocessor, firmware, an application specific integrated circuit (ASIC), and/or a field programmable gate array (FPGA).

The processing unit (14) is configured to calculate a distance between the input (x₀) lying in a first class from the classification boundary of a second class. First, the processing unit (14) calculates a Jacobian gradient of input (x₀) lying in the first class with respect to the classification boundary. Next it modifies the input using the Jacobian gradient and pre-defined scaling factor (a) to generate a secondary input (xₐ₁). The value of scaling factor (a) is adapted until the secondary input generated lies in the second class (xₐ₂). Then the processing unit (14) performs a binary search between the secondary inputs to find a peripheral input closest to the classification boundary (xₐₙ). Finally, the processing unit (14) calculates a distance between the input (x₀) and the peripheral input closest to the classification boundary (xₐₙ) to assess the input fed to the AI Model (M).

While assessing the input, the processing unit (14) calculates the distance between an input and the corresponding peripheral input for a batch for inputs to determine an adversarial batch of inputs. The processing unit (14) further assesses an input as an attack vector if the distance of the input (x₀) from the classification boundary is below a pre-defined threshold. The processing unit (14) communicates the assessment information with the blocker module.

The AI system (10) further comprises at least a blocker module (18) configured to block a user or modify the output when a batch of input queries or an input query is determined as an attack vector. In another embodiment of the present disclosure, the blocker module (18) itself is configured to identify the input fed to AI Model (M) as attack vector. The blocker module (18) is configured to at least restrict a user of the AI system (10) in dependance of the assessment received from the processing unit. It is further configured to modify the original output generated by the AI Model (M) on identification of an input or a batch of input queries as attack vector.

It should be understood at the outset that, although exemplary embodiments are illustrated in the figures and described below, the present disclosure should in no way be limited to the exemplary implementations and techniques illustrated in the drawings and described below.

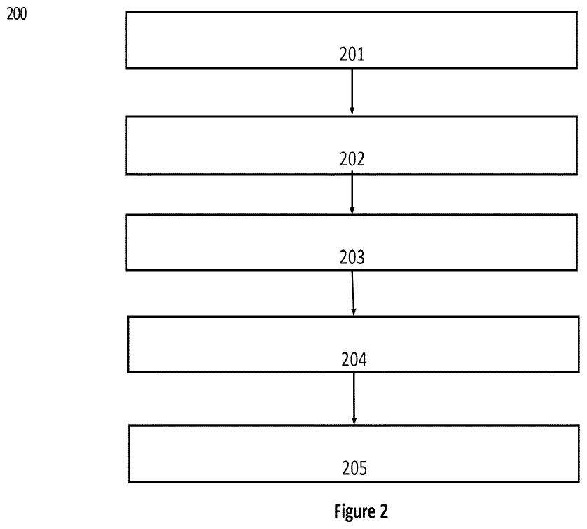

FIG. 2 illustrates method steps (200) of assessing inputs fed to an AI Model (M) in an AI system (10). The AI system (10) has been explained in accordance with FIG. 1. The method steps (200) predominantly are performed by the processing unit.

Method step 201 comprises calculating a Jacobian gradient of input (x₀) lying in the first class with respect to the classification boundary by means of the processing unit. We ensure that we move in the direction of the closest distance by using Jacobian-based augmentation methods, whereby we obtain the gradient of the classification boundary mathematically represented as F (x) with respect to the input (x₀). The negative direction of this gradient will be in the direction of the fastest decrease in the value of the class logit w.r.t. the input.

Method step 202 comprises modifying the input using the Jacobian gradient and pre-defined scaling factor (alpha) to generate a secondary input (xₐ₁) by means of the processing unit.

$${x}_{a 1} = {x}_{o} - ∇ F ( {x}_{o} ) * α ( 1 )$$

Where xₐ is the augmented vector and ∇F(xₒ) is the gradient of F(xₒ) w.r.t. xₒ.

Method step 203 comprises adapting the value of scaling factor (alpha) until the secondary input generated lies in the second class (xₐ₂) by means of the processing unit. we vary the magnitude of the scaling factor pointing in the negative direction of this gradient in the input space to the original input.

Method step 204 comprises performing a binary search between the secondary inputs to find a peripheral input closest to the classification boundary (xₐₙ) by means of the processing unit. During the binary search we divide and conquer the space between (xₐ₂) and (xₐₙ₋₁), wherein (xₐₙ₋₁) is the secondary input generated in the iteration before the secondary input flipped to the second class.

Method step 205 comprises calculating a distance between the input (x₀) and the peripheral input closest to the classification boundary (xₐₙ) to by means of the processing unit (14) assess the input fed to the AI Model (M). Assessing the input of the AI Model (M) comprises calculating the distance between an input and the corresponding peripheral input for a batch for inputs to determine an adversarial batch of inputs. Further the input is assessed as an attack vector if the distance of the input (x₀) from the classification boundary is below a pre-defined threshold.

This assessment information is sent to the blocker module. The blocker module (18) can restrict a user or modify an input based on the assessment. In an alternate embodiment of the present disclosure, rather than blocking or rejecting a plurality of inputs, the blocker module (18) sends out manipulated outputs. The manipulated output is selected as the lowest probability value class, which is the total opposite of the original output class. Hence attacker will receive the wrong output and will not be able to train or exploit models with reasonable accuracy.

Distance measure is helpful in determining how effective an attack vector is in the case of model extraction. An AI Model (M)'s response to vectors with varying distance values helps us understand model extraction better. This information is even more helpful for defending a model since we can identify regions where the most concerning attack vectors is sampled in the input space. Likewise, in model evasion attacks, the distance metric helps us determine whether a given sample is adversarial or not since adversarial samples are much closer to the classification boundary. It is helpful for the memory-based continual learning setup where one might want to sample a diverse set of instances into the limited amount of episodic memory. Other use cases could be found in the fields including but not limited to model calibration, where one can use the distance metric to estimate the confidence of the classification of a given datapoint.

It must be understood that the invention in particular discloses methodology used for assessing an input fed to an AI Model (M) of an AI system (10). While these methodologies describes only a series of steps to accomplish the objectives, these methodologies are implemented in AI system (10), which may be a combination of hardware or software or a combination thereof wherein the components of the AI system (10) may be altered according to requirement.

It must be understood that the embodiments explained in the above detailed description are only illustrative and do not limit the scope of this invention. Any modification and adaptation of the proposed method to assess an input fed to an AI Model (M) of an AI system (10) are envisaged and form a part of this invention. The scope of this invention is limited only by the claims.

1. A method of assessing inputs fed to an AI Model in an AI system, said AI system including the AI Model, a processing unit and at least a blocker module, said AI Model being configured to classify an input into at least two classes including a first class and a second class, and said at least two classes being segregated by a classification boundary, the method comprising:
calculating a Jacobian gradient of input lying in the first class with respect to the classification boundary by way of the processing unit;
modifying the input using the Jacobian gradient and a pre-defined scaling factor to generate a secondary input by way of the processing unit;
adapting the value of the scaling factor until the secondary input generated lies in the second class by way of the processing unit;
performing a binary search between the secondary inputs to find a peripheral input closest to the classification boundary by way of the processing unit; and
calculating a distance between the input and the peripheral input closest to the classification boundary by way of the processing unit to assess the input fed to the AI Model.

2. The method as claimed in claim 1, wherein the assessing the input of the AI Model comprises calculating the distance between the input and the corresponding peripheral input for a batch for inputs to determine an adversarial batch of inputs.

3. The method as claimed in claim 1, wherein the input is assessed as an attack vector if the distance of the input from the classification boundary is below a pre-defined threshold.

4. The method as claimed in claim 1, wherein the assessment information is sent to the blocker module.

5. An AI system adapted to assess inputs fed to an AI Model, said AI system comprising the AI Model, a processing unit and at least a blocker module, said AI Model being configured to classify an input into at least two classes including a first class and a second class, said at least two classes being segregated by a classification boundary, the blocker module being configured to modify the output on an assessment of the input by the processing unit, wherein the processing unit is configured to:
calculate a Jacobian gradient of input lying in the first class with respect to the classification boundary;
modify the input using the Jacobian gradient and a pre-defined scaling factor to generate a secondary input;
adapt the value of the scaling factor until the secondary input generated lies in the second class;
perform a binary search between the secondary inputs to find a peripheral input closest to the classification boundary; and
calculate a distance between the input and the peripheral input closest to the classification boundary to assess the input fed to the AI Model.

6. The AI system as claimed in claim 5, wherein while assessing the input, the processing unit calculates the distance between the input and the corresponding peripheral input for a batch for inputs to determine an adversarial batch of inputs.

7. The AI system as claimed in claim 5, wherein the processing unit assesses as an attack vector if the distance of the input from the classification boundary is below a pre-defined threshold.

8. The AI system as claimed in claim 5, wherein the processing unit communicates the assessment information with the blocker module.

9. The AI system as claimed in claim 5, wherein the blocker module is configured to at least restrict a user of the AI system in dependance of the assessment received.
